(19) United States
(12) Patent Application Publication
(10) Pub. No.: US 2026/0143317 A1
(43) Pub. Date: May 21, 2026

(54) SYSTEMS AND METHODS FOR DETECTING A VEHICLE EVENT

(71) Applicant: ALLSTATE INSURANCE COMPANY, NORTHBROOK, IL (US)

(72) Inventors: MICHAEL O'CONNOR, NORTHBROOK, IL (US); CHASE DAVIS, Castle Rock, CO (US); JEFFREY SCHLITT, Libertyville, IL (US); CHARLES FULLER, Seattle, WA (US); THEODORE BABITZ, Golden, CO (US)

(21) Appl. No.: 19/390,944

(22) Filed: Nov. 17, 2025

Related U.S. Application Data
(60) Provisional application No. 63/720,895, filed on Nov. 15, 2024.

(51) Int. Cl. H04W 4/44; G07C 5/04

(52) U.S. Cl. CPC H04W 4/44; G07C 5/04

(57) ABSTRACT

Aspects of the disclosure relate to computer systems and/or methods to determine whether a vehicle event occurred during a trip. A computer model may be implemented on one or more computing devices in a vehicle computing environment to monitor sensor outputs from one or more sensors of the computing devices, and/or monitor outputs of one or more sub-models running on the computing devices to detect a vehicle event occurred. The computer model may predict whether roadside assistance is needed for a vehicle event based on the sensor output and/or the output of one or more sub-models. For example, based on a prediction that roadside assistance is needed, the computer model may generate a request for the roadside assistance and transmit the request to a service provider to provide the roadside assistance.

### CROSS-REFERENCE TO RELATED APPLICATIONS

This claims priority to U.S. Provisional Ser. No. 63/720,895 , filed on Nov. 15, 2024, the entire contents of which are incorporated by reference herein.

### FIELD

This invention generally relates to systems and methods for detecting a vehicle event.

### BACKGROUND

Vehicle safety monitoring and emergency response systems have become increasingly important as vehicle technology advances. Conventional systems suffer from significant limitations that compromise their effectiveness in critical safety situations. These conventional systems often depend on single data sources or isolated device monitoring, which limits the accuracy in determining whether vehicle events occurred during operation of a vehicle. Conventional systems also rely on remote server-based processing that introduces substantial communication delays, reducing the speed of emergency response when time-critical situations such as a vehicle crash occurs. Furthermore, conventional systems require manual user intervention to initiate emergency communications, creating additional delays that may be critical in situations where drivers may need roadside assistance.

### SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

The present disclosure provides, in one aspect, a method comprising monitoring, using a model, a first output of a first sensor of a vehicle, the first output including vehicle data associated with the vehicle during a trip, and monitoring, using the model, a second output of a second sensor of a mobile device, the second output including mobile device sensor data associated with the mobile device during the trip, and the mobile device associated with a driver of the vehicle. The method also includes processing, using the model, the vehicle data and the mobile device sensor data to detect a vehicle event occurred during the trip, predicting, using the model and based on the vehicle data and the mobile device sensor data, whether roadside assistance is needed for the vehicle event, and generating a request for the roadside assistance based on the prediction that the roadside assistance is needed. The method also includes transmitting the request for the roadside assistance to a service provider to provide the roadside assistance.

The present disclosure provides, in another aspect, a computing system comprising a processor, a memory storing computer-executable instructions that, when executed by the processor, cause the processor to: monitor, using a model, a first output of a first sensor of a vehicle, the first output including vehicle data associated with the vehicle during a trip, and monitor, using the model, a second output of a second sensor of a mobile device, the second output including mobile device sensor data associated with the mobile device during the trip, and the mobile device associated with a driver of the vehicle. The computing system also includes processing, using the model, the vehicle data and the mobile device sensor data to detect a vehicle event occurred during the trip, predict, using the model and based on the vehicle data and the mobile device sensor data, whether roadside assistance is needed for the vehicle event, and generating a request for the roadside assistance based on the prediction that the roadside assistance is needed. The computing system also includes transmitting the request for the roadside assistance to a service provider to provide the roadside assistance.

The present disclosure provides, in another aspect, one or more non-transitory computer-readable media storing instructions that, when executed by a processor, cause the processor to monitor, using a model, a first output of a first sensor of a vehicle, the first output including vehicle data associated with the vehicle during a trip, and monitor, using the model, a second output of a second sensor of a mobile device, the second output including mobile device sensor data associated with the mobile device during the trip, and the mobile device associated with a driver of the vehicle. The one or more non-transitory computer-readable media storing instructions also includes processing, using the model, the vehicle data and the mobile device sensor data to detect a vehicle event occurred during the trip, predicting, using the model and based on the vehicle data and the mobile device sensor data, whether roadside assistance is needed for the vehicle event, and generating a request for the roadside assistance based on the prediction that the roadside assistance is needed. The one or more non-transitory computer-readable media storing instructions also includes transmitting the request for the roadside assistance to a service provider to provide the roadside assistance.

The arrangements described can also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals.

FIG. 1 illustrates components of an event detection system according to one or more embodiments.

FIG. 2 illustrates a network environment and computing system that may be used to implement aspects of the disclosure.

FIG. 3 illustrates components of a computing device according to one or more embodiments.

FIGS. 4A-4D illustrates a management model implemented on one or more computing devices.

FIG. 5 is a flow chart illustrating an example method of detecting and determining whether an event occurred based on input from multiple data sources.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further below, systems and methods for detecting an event using a management model or processing framework are described. For example, an event such as a vehicle crash may be identified based on data from one or more computing devices. The one or more computing devices may include a vehicle, a mobile device, and/or an additional device. The management model may be implemented on one or more computing devices in a computing environment, collect/analyze the associated sensor data, and detect a vehicle event occurred during a trip. In other embodiments, the management model may collect/analyze outputs from sub-models, and detect a vehicle event occurred during a trip based on one or more combinations of sensor output and output from sub-models.

The management model may monitor one or more of: sensor outputs of computing devices in the vehicle environment or outputs of sub-models running on the computing devices in the vehicle environment to detect a vehicle event occurred. The management model may also predict whether roadside assistance may be needed for the detected vehicle event. The management model may compare the sensor output and/or output from sub-models to one or more thresholds indicating roadside assistance may be needed for a detected vehicle event. Based on the prediction that roadside assistance may be needed for the detected vehicle event, the management model may generate an output (e.g., alert, notification, request) that the vehicle event occurred and transmit the output to an enterprise, a service provider, a computing device associated with a service provider, or an emergency service. In some examples, the output may be used to provide the appropriate service or service provider to a driver to ensure their safety during operation of the vehicle.

Accordingly, by utilizing a software model (e.g., computer model, management model) to monitor one or more of: sensor outputs of computing devices or outputs of sub-models running on the computing devices, improves vehicle event detection accuracy and a driver's safety while operating a vehicle. Further, the capability of the software model to operate on multiple computing devices and analyze the associated sensor data (e.g., rather than using disparate software models dispersed on multiple platforms, which increases the amount of processing power), increases the likelihood that the software model predicts that an event occurred. The software model adaptable to multiple computing platforms and multiple data formats reduces the processing power used to predict that a vehicle event occurred.

### Computing Devices and Operating Environment

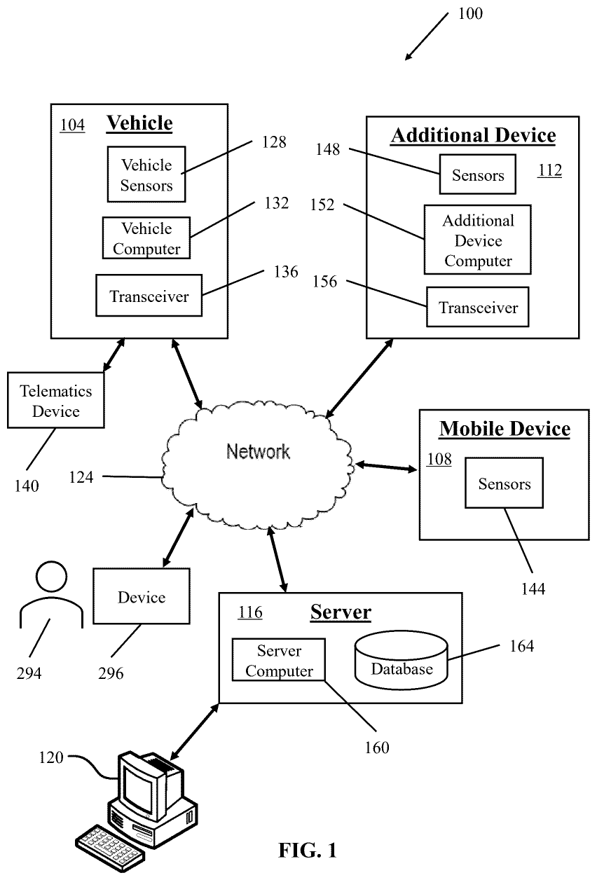

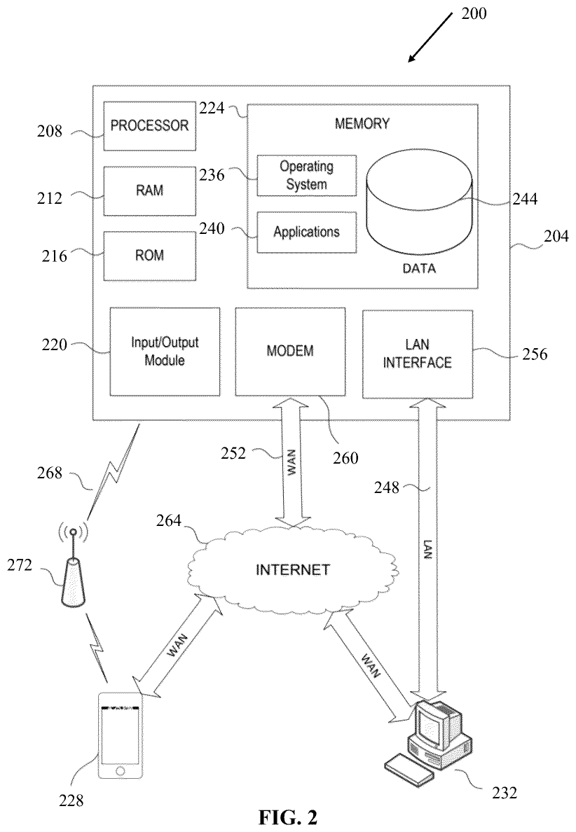

FIGS. 1 and 2 illustrates components of an event detection system 100 according to one or more embodiments. The event detecting system 100 may include one or more computing devices such as a vehicle 104, one or more mobile devices 108, one or more additional devices 112, a server 116, and a terminal 120 connected to the server 116. Any of the devices and systems described in this disclosure may be implemented, in whole or in part, using one or more computing devices (or computer devices) described with respect to FIG. 2.

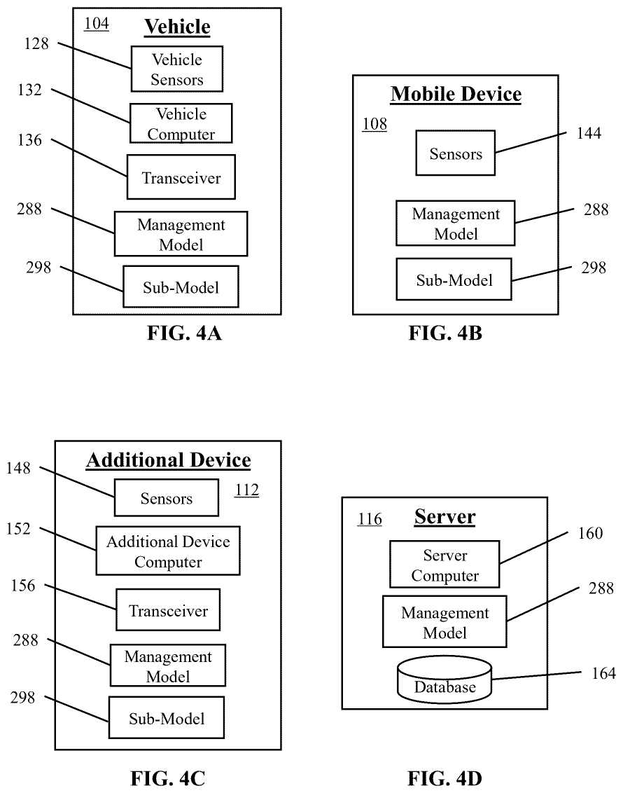

The vehicle 104 may be an automobile, motorcycle, scooter, bus, recreational vehicle, boat, or other vehicle for which sensor data may be collected and analyzed. The vehicle 104 may contain some or all of the hardware/software components of the computing devices described with respect to FIG. 2. The vehicle 104 includes one or more vehicle sensors 128, a vehicle computer 132, and a transceiver 136 (FIGS. 1 and 4A). The vehicle sensors 128 may be used to collect and/or receive sensor data from the vehicle 104. The vehicle computer 132 may receive, store, process, and/or transmit sensor data from the vehicle 104. The vehicle computer 132 may be used to process sensor data and determine data to send to other devices or servers in the system 100. The vehicle transceiver 136 may be used for transmitting and receiving data from the vehicle sensors 128.

The vehicle 104 may further include a telematics device 140 integrated with the vehicle 104 and/or an aftermarket telematics device 136. The telematics device 140 may be used to track location, vehicle diagnostics, speed, acceleration, and the like. In some aspects, the aftermarket telematics device 140 may be connected to the vehicle by wire, such as via the vehicle's OBD port. Aftermarket devices may additionally or alternatively connect to the vehicle 104 (or other devices within the vehicle 104, such as a mobile device 108) wirelessly.

The mobile device 108 may contain some or all of the hardware/software components of the computing devices described with respect to FIG. 2. Software applications may be installed on and execute on the mobile device 108. The software applications may be configured to receive sensor data from one or more mobile device sensors 144, such as acceleration, velocity, location, and the like (FIGS. 1 and 4B). The mobile device 108 may be equipped with Global Positioning System (GPS) functionality that determines vehicle location, speed, direction, and other basic driving data without needing to communicate with the vehicle 104, the additional device 112, and/or other devices.

The additional device 112 may be a device within the vehicle 104, a device outside the vehicle 104, a device within a threshold distance from the vehicle 104 or mobile device 108, a video device, a traffic device, a server, a personal tracking device (e.g., watch, fitness tracking device), and/or other devices capable of receiving and transmitting sensor data. In some examples, the additional device 112 may include a traffic light, which may determine and store time and status data, such as whether the traffic light was red, yellow, or green at each point of time. In another example, the additional device 112 may also include a traffic camera on the road (e.g., a standalone camera, a camera integrated in a traffic light, and the like) or a traffic camera in the air (e.g., a camera on a drone, a helicopter, an airplane, or any other aerial vehicle, whether manned or unmanned). The additional device 112 may contain some or all of the hardware/software components of computing devices described with respect to FIG. 2.

As shown in FIGS. 1 and 4C, the additional device 112 may include one or more sensors 148, an additional device computer 152, and a transceiver 156. The additional device sensors 148 may include location sensors and/or image sensors (e.g., cameras or location sensors, or GPS sensors). The additional device sensors 148 may be used to collect and/or receive sensor data from the additional device 112. The additional device computer 152 may be used to process sensor data and determine data to send to other devices or servers in the system 100. The additional device transceiver 156 may be used for transmitting and receiving data from the additional device sensors 148.

As shown in FIGS. 1 and 4D, the server 116 may include a server computer 160 and a server database 164. The server computer 160 may contain some or all of the hardware/software components of the computing devices described with respect to FIG. 2. The server 116 may store software used by the server computer 160, such as an operating system, application programs, and an associated internal or external database. The server 116 may receive, process, and analyze sensor data from the vehicle 104, the mobile device 108, the additional device 112, other devices, and/or other servers.

The vehicle 104, mobile device 108, additional device 112, and the server 116 may be configured for transmitting, receiving, and/or analyzing data or sensor data. Data may include outputs from one or more computer sub-models or metadata as described in more detail below. Sensor data may include data collected from mobile devices (e.g., a driver's mobile phone, a passenger's mobile phone, a pedestrian's mobile phone), vehicle sensors, on-board diagnostic (OBD) systems, off the shelf devices, and/or additional devices. Sensor data may refer to information pertaining to one or more actions or events performed or observed by a vehicle, a pedestrian, a mobile device, or additional devices. Sensor data may also include aspects of information identified or determined from data collected from a vehicle, a device within the vehicle, a device outside the vehicle, a stationary device, a traffic device, a video device, or a mobile device. Sensor data can include, for example, location data, speed or velocity data, acceleration data, presence data, time data, direction data, mobile device orientation data, rotation/gyroscopic data, image sensor data, and the like.

As shown in FIG. 1, the vehicle 104, the mobile device 108, the additional device 112, and the server 116 may communicate over a network 124. The network 124 may include a local area network (LAN), a wide area network (WAN), a wireless telecommunications network, and/or any other communication network or combination thereof. The network 124 may be implemented, in whole or in part, using the network connections described with respect to FIG. 2.

FIG. 2 illustrates a computing device 204 (or computer device 204) in a network environment 200 according to an embodiment of the disclosure. The computing device 204 may have a processor 208 for controlling overall operation of the computing device and its associated components, including RAM 212, ROM 216, input/output module 220, and memory unit 224. The computing device 204 and one or more additional devices (e.g., terminals 228, 232) may correspond to any of multiple systems or devices, such as event detection systems or devices, configured as described in this disclosure for receiving data from vehicles, mobile devices, additional devices, and using the data to determine whether an event occurred.

As shown in FIG. 2, input/output (I/O) module 220 may include a microphone, keypad, touch screen, and/or stylus through which a user of the computing device 204 may provide input, and may also include one or more of a speaker for providing audio input/output and a video display device for providing textual, audiovisual and/or graphical output. Software may be stored within memory unit 224 and/or other storage to provide instructions to processor 208 for enabling computing device 204 to perform various functions. For example, memory unit 224 may store software used by the computing device 204, such as an operating system 236, application programs 240, and an associated internal database 244. The memory unit 224 includes one or more of volatile and/or non-volatile computer memory to store computer-executable instructions, data, and/or other information. Processor 208 and its associated components may allow the computing device 204 to execute a series of computer-readable instructions to receive data from vehicles, mobile devices, additional devices, servers, and/or other devices, and using the data to determine whether an event occurred.

With continued reference to FIG. 2, the computing device 204 may operate in the networked environment 200 supporting connections to one or more remote computers, such as terminals/devices 228, 232. The computing device 204 and related terminals/devices 228, 232 may include devices installed in vehicles, mobiles devices that travel within vehicles, or devices outside of the vehicles that are configured to receive and process and contextual data. The computing device 204 and terminals/devices 228, 232 may each include personal computers (e.g., laptop, desktop, or tablet computers), servers (e.g., web servers, database servers), vehicle-based devices (e.g., on-board vehicle computers, short-range vehicle communication systems, sensors and telematics devices), or mobile communication devices (e.g., mobile phones, portable computing devices, and the like). The terminals 228, 232 may include some or all of the elements described above with respect to the computing device 204.

As shown in FIG. 2, the network connections may include a local area network (LAN) 248, a wide area network (WAN) 252, and a wireless telecommunications network 256. In other embodiments, the networked environment 200 may include other network connections. When used in a LAN networking environment, the computing device 204 may be connected to the LAN 248 through a network interface or adapter 256. When used in a WAN networking environment, the computing device 204 may include a modem 260 or other means for establishing communications over the WAN 252, such as a network 264 (e.g., the Internet). When used in a wireless telecommunications network 268, the computing device 204 may include one or more transceivers, digital signal processors, and additional circuitry and software for communicating with wireless computing devices 228, 232 (e.g., mobile phones, short-range vehicle communication systems, vehicle sensing and telematics devices) via one or more network devices 272 (e.g., base transceiver stations) in the wireless telecommunications network 268.

It will be appreciated that the network connections shown in FIG. 2 are illustrative and other means of establishing a communications link between the computing devices may be used. The existence of any of various network protocols such as TCP/IP, Ethernet, FTP, HTTP and the like, and of various wireless communication technologies such as GSM, CDMA, Wi-Fi, and WiMAX, is presumed, and the various computing devices and risk map generation system components described herein may be configured to communicate using any of these network protocols or technologies.

Additionally, one or more application programs 240 used by the computing device 204 may include computer executable instructions (e.g., event detection algorithms, and the like) for receiving vehicle data, mobile device data, and additional device data to determine whether an event occurred based on the one or more data sources.

### Detecting and Determining Events Using One or More Computer Models

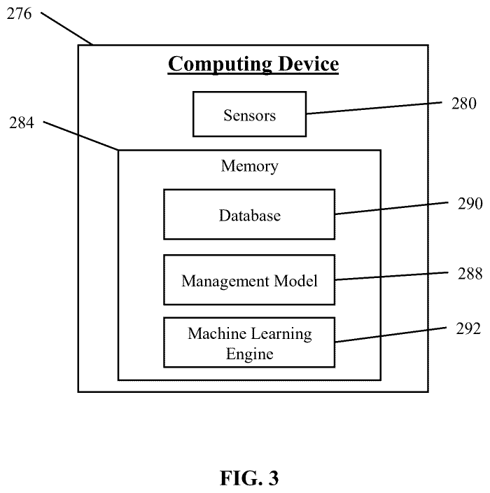

With reference to FIG. 3, a computing device 276 may include one or more sensors 280 and a memory 284. The sensors 280 may be similar to the sensors described in this disclosure (e.g., sensors 128, 144, 148). The memory 284 may be similar to the memory unit 224 described above. The computing device 276 may further include some or all of the hardware/software components of the computing devices described with respect to FIG. 2. As described in more detail below, the memory 284 may have, store, and/or include a management model 288 to determine whether a vehicular event occurred. The management model 288 and/or the computing device 276 may also be referred to as a processing framework that may determine whether a vehicular event occurred.

The term “event” may generally refer to one or more events associated with a user or driver during operation of a vehicle. The term “event” may also be referred to as “vehicle event.” In some embodiments, the events may be associated with the user's safety during operation of a vehicle. For example, the events may relate to one or more of: a vehicle crash, a wrong way direction incident, an excessive speed incident, a distracted driving incident, tow assistance, help request, and other safety events. In some examples, the notification and the information about the event may be used by a human, a parent, a family relative, an enterprise such as an insurance provider, a service provider, or an emergency service to ensure the safety of a user.

In some embodiments, the computing device 276 may be an edge computing device that provides localized processing capabilities within or proximate to the vehicle environment. The management model 288 may be installed and/or execute on the one or more edge computing devices. An edge computing device may refer to a computing device positioned at or near a data source (e.g., vehicle 104, mobile device 108, additional device 112) that performs data processing locally rather than relying on remote cloud-based or centralized server processing.

The edge computing device provides several technological improvements over conventional remote processing architectures. The edge computing device may reduce processing latency by eliminating the need to transmit sensor data to remove server for analysis and then receiving processing results back to a location of the data source (e.g., vehicle 104, mobile device 108, additional device 112). This reduction in communication time improves the response times of the computing system for determining an appropriate service provider to respond to a vehicle event.

The edge computing device may include specialized processing hardware optimized for machine learning and real-time data processing, such as graphical processing units (GPUs), tensor processing units (TPUs), or field-programmable gate arrays (FPGAs). Specialized processing components enable the management 288 and the machine learning engine 292 to perform complex real-time analysis of multiple sensor data streams with improved computational efficiency.

In operation, the edge computing device receives and processes sensor data locally, applying the management model 288 to detect vehicle events in real-time. The processed data or results, event determinations, and/or relevant metadata may be transmitted over the network 124 to external systems, which may reduce bandwidth usage compared to systems that transmit raw sensor data for remote processing. The edge computing device may allow for a selective data transmission approach that may also enhance privacy by keeping detailed sensor data local to the vehicle environment.

With reference to FIGS. 4A-4D , the computing device 276 may be one or more computing devices as described in this disclosure. For example, the computing device 276 may be the vehicle 104, the mobile device 108, the additional device 112, the server 116, and/or other devices in the system 100. For example, as shown in FIG. 4A, the vehicle 104 may include the management model 288. The management model 288 may receive sensor data from the vehicle sensors 128 and may determine whether an event occurred. In another example, as shown in FIG. 4B, the mobile device 108 may include the management model 288. The management model 288 may receive sensor data from the mobile device sensors 144 and may determine whether an event occurred. In another example, as shown in FIG. 4C, the additional device 112 such as a traffic device may include the management model 288. The management model 288 may receive sensor data (e.g., location sensor data or image sensor data) from the additional device sensors 148 and may determine whether an event occurred. In another example, as shown in FIG. 4D, the server 116 may include the management model 288. The management model 288 may receive sensor data from the sensors 128, 144, 148 and may determine whether an event occurred. Still, in other examples, other devices may include the management model 288 to detect or determine whether an event associated with a vehicle occurred.

In other embodiments, a plurality of computing devices may include the management model 288. In other words, the management model 288 may be installed and/or execute on a plurality of computing devices. For example, the vehicle 104 and the server 116 may include the management model 288. The management model 288 may receive sensor data from the vehicle sensors 128, process/analyze the sensor data from the vehicle sensors 128 on one or both the vehicle 104 and the server 116, and determine whether an event occurred. It would be appreciated the management model 288 may be installed and/or executed on one or more combinations of: the vehicle 104, the mobile device 108, the additional device 112, and the server 116. In some embodiments, the management model 288 may include cross-platform computing capabilities (e.g., software or instructions). For example, the cross-platform computing capabilities may allow the management model 288 to be deployed on multiple computing platforms (e.g., CPUs, GPUs, TPUs, mobile operating systems, desktop operating systems). The management model 288 may analyze multiple types of data and be installed/executed on multiple computing platforms to determine whether an event occurred.

The management model 288 and/or the computing device 276 may monitor one or more sensors of the vehicle 104, the mobile device 108, the additional device 112, and/or any combination thereof. In other words, the management model 288 and/or the computing device 276 may monitor an output of one or more sensors of the vehicle 104, the mobile device 108, the additional device 112, and/or any combination thereof. For example, the management model 288 and/or the computing device 276 may monitor the vehicle sensors 128, the mobile device sensors 144, the additional device sensors 148, and/or any combination thereof.

The management model 288 and/or the computing device 276 may prioritize and/or weigh sensor data to determine whether an event occurred during a vehicular trip. For example, based on a determination that an event occurred, the management model 288 and/or the computing device 276 may apply a greater weight to sensor data received from the vehicle 104 than the sensor data from the mobile device 108, or vice versa. Weighting the sensor data from various sources may increase the event detection accuracy. In other embodiments, weighting the sensor data may be for one or more combinations of: the vehicle 104, the mobile device 108, the additional device 112, and other computing devices in the system 100.

In some embodiments, the management model 288 and/or the computing device 276, after detecting an event occurred, may receive or request additional sensor data to further improve the contextual accuracy of the event. The management model 288 and/or the computing device 276 may pause monitoring of sensor output from one or more computing devices in the system 100 to improve data transmission and analysis over the network 124. For example, the management model 288 and/or the computing device 276 may monitor the output of one or more sensors of the vehicle 104 and the mobile device 108, and determine that the sensor output of the mobile device 108 indicated the occurrence of the event (e.g., measured aspect of the vehicle such as acceleration, velocity, orientation). In this example, the management model 288 and/or the computing device 276 may receive or request additional data from the sensors 144 of the mobile device 108 to validate the occurrence of the event and/or improve accuracy of the event. In some embodiments, the management model 288 and/or the computing device 276 may pause monitoring of the sensor output of the vehicle 104 while receiving additional data from the sensor output of the mobile device 108. In other examples, the management model 288 and/or the computing device 276 may pause monitoring of the sensor output of the mobile device 108 while receiving additional data from the sensor output of the vehicle 104 based on a determination that the sensor output of the vehicle 104 indicated the occurrence an event. The management model 288 and/or the computing device 276 may receive additional data and/or pause monitoring of the sensor output for one or more combinations of: the vehicle 104, the mobile device 108, the additional device 112, and other computing devices in the system 100.

In other embodiments, the management model 288 and/or the computing device 276 may prioritize and/or weight sensor data and an output of a sub-model 298 running on a computing device in the system 100. For example, the management model 288 and/or the computing device 276 may apply a greater weight to an output of a sub-model 298 (e.g., vehicle crash model, distracted driving model, vehicle aspect model such as acceleration, velocity, orientation) than sensor data from the vehicle 104, the mobile device 108, the additional device 112, and/or other computing devices in the system 100. As described in more detail below, the management model 288 and/or the computing device 276 may receive an output of a sub-model 298 running on a computing device in the system 100 to detect an event occurred.

In other embodiments, the management model 288 and/or the computing device 276 may monitor the output of a sub-model 298 running on the mobile device 108 and the one or more sensors of the vehicle 104, and determine that the output of the sub-model 298 indicated the occurrence of the event. In this example, the management model 288 and/or the computing device 276 may pause the monitoring of the sensor output from the vehicle 104, and receive additional data from the mobile device 108 (e.g., sensor output of mobile device 108, or output from other sub-models 298 running on the mobile device 108). It would be appreciated that the management model 288 and/or the computing device 276 may receive additional data in the form of sensor outputs or outputs from sub-models 298 running on computing devices, and pause monitoring of sensor outputs for one or more combinations of: the vehicle 104, the mobile device 108, the additional device 112, and other computing devices in the system 100.

Still, in other embodiments, the management model 288 and/or the computing device 276 may monitor driving behaviors during operation of the vehicle 104. The management model 288 and/or the computing device 276 may identify or determine driving behaviors based on the sensor output of one or more computing devices in the system 100 and/or the output of one or more sub-models 298 running on the one or more computing devices in the system 100. For example, the driving behaviors may indicate behaviors a driver exhibits during operation of the vehicle 104 including behaviors related to speed, acceleration, braking, turning, and direction. The driving behaviors may include safe driving behaviors and/or unsafe driving behaviors. For example, the driving behaviors may include behaviors associated with the mobile device 108, whether a driver turns on or off a mobile device 108, or a position of a mobile device 108 in the vehicle 104 (e.g., in a mount, in a driver's hand, in a center console, or in a seat).

The management model 288 and/or the computing device 276 may compare the driving behaviors identified from the sensor data and/or output of sub-models 298 to one or more driving behavior thresholds. In some embodiments, if a driver exhibits a driving behavior above or below a driving behavior threshold, the management model 288 and/or the computing device 276 may generate an output (e.g., request for roadside assistance, alert, or notification) and the transmit the output to an appropriate service provider, enterprise, or entity. The management model 288 and/or the computing device 276 may be monitor one or more driving behaviors over a period of time (or predetermined period of time) to improve accuracy of behavior detection. For example, as a driver improves one or more particular driving behaviors over time, the management model 288 and/or computing device 276 may determine the one or more particular driving behaviors may be improved, and update/remove (e.g., from database, memory) the improved particular driving behaviors with different one or more driving behaviors to be monitored. The management model 288 and/or the computing device 276 may be updated with one or more driving behaviors and/or one or more driving behavior thresholds that may be desirable for monitoring during operation of the vehicle 104. The management model 288 and/or the computing device 276 may be continuously, at intervals, in real-time, and/or periodically be updated with driving behaviors and/or driving behavior thresholds desirable for monitoring during operation of the vehicle 104.

The memory 284 may have, store, and/or include the management model 288, a database 290, and a machine learning engine 292. Using sensor data from the sensors 280, the management model 288 may include instructions that direct the computing device 276 to detect whether an event has or has not occurred. The management model 288 may include instructions that direct the computing device 276 to output a request for roadside assistance, a notification, and/or information about the event. In some embodiments, the management model 288 may be software installed on and executed on the computing device 276. The management model 288 may include software elements, hardware elements, a combination of both software and hardware elements, or any combination thereof.

The database 290 may store information used by the computing device 276, the management model 288, and/or the machine learning engine 292 in determining whether an event occurred. The database 290 may store data associated with the computing device 276, event types, and/or data affirming or confirming events. For example, the database 290 may store sensor data associated with the computing device 276 and/or sensor data affirming events. The database 290 may store historical sensor data and data that may affirm or confirm the occurrence of an event associated with a vehicle.

With continued reference to FIG. 3, the machine learning engine 292 may include instructions that direct and/or cause the computing device 276 to determine whether an event occurred. The machine learning engine 292 may set, define, and/or iteratively refine optimization rules, techniques, and/or other parameters used by the computing device 276 and/or other computing devices in the system 100.

The computing device 276 may train the machine learning engine 292 to determine whether an event occurred. The machine learning engine 292 may utilize one or more tools such as, for example, a linear regression, a decision tree, a support vector machine, a random forest, a k-means algorithm, gradient boosting algorithms, gradient boosted tree model algorithm, dimensionality reduction algorithms, and the like. For example, the machine learning engine 292 may be provided with historical data and affirmation of events (e.g., vehicle crash, speeding event, etc.) based on the historical data. Accordingly, the machine learning engine 292 may be trained via supervised learning techniques to learn an association between the historical data and affirmed events. The machine learning engine 292 may be trained to determine additional events based on received data.

Additionally or alternatively, the computing device 276 may train the machine learning engine 292 using metadata corresponding to the received data (e.g., sensor data or output of sub-model 298). The computing device 276 may identify metadata including one or more of: a geolocation corresponding to the vehicle 104, orientation of the vehicle 104, orientation of the mobile device 108, images captured from an additional device 112 such as traffic devices or video devices, or image or sensor data from an additional device 112 within or outside the vehicle 104. The computing device 276 may analyze the data in the context of the metadata and determine whether an event occurred using the management model 288 and the machine learning engine 292.

Additionally or alternatively, the computing device 276 may train the machine learning engine 292 using an output from one or more sub-models 298, where each sub-model 298 may be intended to identify an occurrence of an event. The sub-model 298 may analyze sensor data associated with the computing device 276, and output information about an event based on the sensor data. The sub-model 298 may output information including one or more of: a vehicle crash, a wrong way driver incident, an excessive speed incident, a distracted driving incident, and other suitable information relating to safety. The management model 288 may utilize the output of one or more sub-models 298 in part to determine whether an event occurred.

The trained machine learning engine 292 may infer whether an event occurred based on the available data at the time of the event. The available data may include multiple data sources (e.g., vehicle 104, mobile device 108, additional device 112) or types of data (e.g., sensor data, metadata, output from sub-models 298). For ease of understanding, the example below is described with reference to the vehicle 104 and the mobile device 108. In other embodiments, the example below may be applied to one or more combinations of: the vehicle 104, the mobile device 108, the additional device 112, the server 116, and other devices in the system 100.

For example, a human user 294 may define a set of rules (i.e., rules or conditions that indicate an event) which may be used by the management model 288 (FIG. 1). For example, the human user 294 may be a parent that wants to ensure safety of a user (i.e., child) during operation of the vehicle 104. The vehicle 104 and the mobile device 108 may include the management model 288. If an event occurs, the management model 288 using the trained machine learning engine 292 may triage the sensor data from the vehicle 104 and the mobile device 108. The trained machine learning engine 292 may analyze the sensor data from the vehicle 104 and the mobile device 108 in view of the set of rules. The trained machine learning engine 292 may determine, from the sensor data (i.e., vehicle 104 and mobile device 1018) and based on the set of rules, the event occurred. The management model 288 generates an output corresponding to the event, and sends one or more commands directed to the vehicle 104, the mobile device 108, and/or a device 296 associated with the human user 294 to display the output.

The output of the management model 288 may include an alert or notification indicating whether an event occurred. The alert or notification may include a sound, a motion, or a display indication on a device, an enterprise device, or a vehicle, or other devices connected to the network 124. The alert or notification may include information related to the event type (e.g., vehicle crash or wrong way direction incident), time, date, location, etc. In some examples, the alert or notification may be sent to a human, a parent, a family relative, an enterprise such as an insurance provider, a service provider, or an emergency service. In some examples, the alert or notification is used to provide the appropriate service to a user to ensure safety during vehicle operation. The management model 288 may transmit an alert, a notification, or a request for roadside assistance automatically to a service provider or associated computing device based on a determination that a vehicle event occurred. In other examples, the alert or notification may allow a user involved in an event (e.g., vehicle crash, tow assistance, distracted driving incident) receives the appropriate service to ensure the user's safety during operation of the vehicle 104. In other examples, the output of the management model 288 may include a request for roadside assistance. The request for roadside assistance may be transmitted to a service provider to provide the requested roadside assistance. In some embodiments, the associated sensor data and/or output of one or more sub-models 298 may be transmitted alongside the request for roadside assistance to a service provider.

Further, the management model 288 and/or the computing device 276 may predict whether roadside service assistance may be needed based on a detection of a vehicle event. For example, an outcome of a detected vehicle event may exceed a threshold that indicates roadside assistance is needed or required. For example, the management model 288 and/or the computing device 276 may compare a detected vehicle event (e.g., sensor outputs from computing devices in system 100 and/or output of sub-model 298) to one or more thresholds that indicate roadside assistance is needed or required. In other words, one or more thresholds may be used by the management model 288 and/or computing device 276 to predict that an outcome of a detected vehicle event would require roadside assistance. For example, one or more thresholds may include speed, acceleration, vehicle orientation, vehicle location, vehicle direction, mobile device location, and/or mobile device orientation thresholds. It would be appreciated that other thresholds may considered to predict whether a driver needs roadside assistance based on a detection of a vehicle event.

### Predicting Events Based on One or More Data Sources

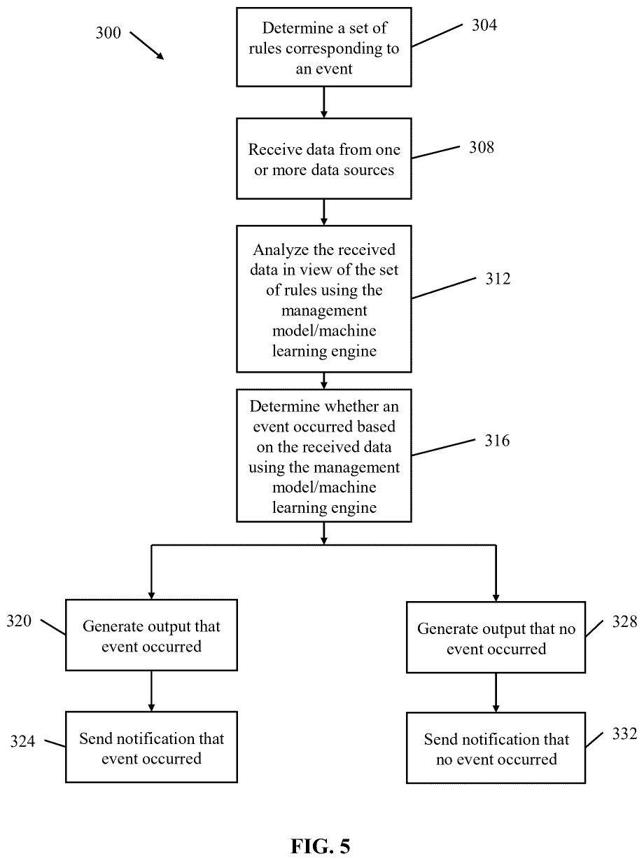

FIG. 5 is a flow chart illustrating a process 300 for identifying and predicting events based on one or more data sources. Some or all of the steps of process 300 can be performed using any of the computing devices and/or combination thereof described in this disclosure. In a variety of embodiments, some or all of the steps described below can be combined and/or divided into sub-steps as appropriate.

At step 304, the computing device 276 may receive a set of rules corresponding to an event. For example, a human user 294 may determine the set of rules corresponding to the event. The computing device 276 may receive the set of rules from the device 296 associated with the human user 294. The set of rules may include threshold values or operation status of a vehicle 104. For example, the set of rules may include a speed or acceleration threshold value (e.g., for an excessive speed event). In another example, the set of rules may include a vehicle orientation or direction (e.g., for a vehicle crash event).

At step 308, the computing device 276 may receive (e.g., via wireless or wired transmission) data from one or more data sources. For example, the computing device 276 may receive data from a first data source, a second data source, a third data source, a fourth data source, and/or a fifth data source. The computing device 276 may receive data from any number of data sources. For example, a first data source may be the vehicle 104, a second data source may be the mobile device 108, and a third data source may be the additional device 112 (e.g., traffic device, camera device), where the computing device 276 may be a device within the vehicle 104 and connected to the network 124. In other words, the management model 288 may monitor one or more sensors of the vehicle 104, the mobile device 108, the additional device 112, and/or any combination thereof.

At step 312, the computing device 276 may analyze the data received in step 308 using the management model 288. In other words, the computing device 276 may analyze the data received in step 208 in view of the set of rules using the management model 288. For example, the data received in step 308 may include sensor data. The management model 288 including the machine learning engine 292 may infer whether an event occurred based on sensor data from all available data sources in the network 124. The sensor data may include acceleration data, direction data, mobile device orientation data, rotation data, date and time data, and/or any other data that may be used by the computing device 276 to determine whether an event occurred. The sensor data may include images (including still or moving images) captured by the vehicle 104, the mobile device 108, and/or the additional device 112.

Alternatively or additionally, at step 312, the computing device 276 may analyze the data received in step 308 using the management model 288. For example, the data received in step 308 may include an output from one or more sub-models 298. The management model 288 including the machine learning engine 292 may infer whether an event occurred based on the output from one or more sub-models 298 running on one or more of: the vehicle 104, the mobile device 108, and/or the additional device 112. The sub-model 298 may include a model for one or more of: a vehicle crash, a distracted driver incident, a wrong way incident, and/or an excessive speeding incident. For example, the sub-model 298 may be a vehicle crash sub-model 298 that determines when the vehicle 104 is involved in a crash (e.g., acceleration of the vehicle 104 is above a threshold acceleration, change in velocity of the vehicle 104, and/or change in direction of the vehicle 104 from normal road conditions). In another example, the sub-model 298 may be an excessive speed sub-model 298 that determines when the vehicle 104 is at a velocity greater than a predetermined threshold. Further, in another example, the sub-model 298 may be a distracted driver sub-model 298 that determines when the vehicle 104 is operating abnormally (e.g., speed changes, direction changes, swerving, etc.).

At step 316, the management model 288 may determine that the event occurred based the data analyzed at step 312. The management model 288 may determine that the event occurred based on the set of rules (e.g., received sensor data matches rules or conditions provided at step 304). The management model 288 may determine that the event occurred based on one or more driving thresholds. In some embodiments, the management model 288 may receive additional data from one or more computing devices in the system 100 while pausing monitoring of the other of the one or more computing devices in the system 100 to further improve event detection accuracy or validate that the event occurred. For example, the management model 288 may receive additional data from the mobile device 108, while pausing monitoring of a sensor output of the vehicle 104, or vice versa. For example, the management model 288 may determine the event occurred if the acceleration of the vehicle 104 is above a threshold acceleration, if the change in direction or orientation of the vehicle 104 is above a threshold, etc. An event may be detected based on a combination of sensor readings, such as acceleration data readings, gyroscope readings, GPS readings, and/or image readings. If the sensor data includes images, the management model 288 may process the images to determine an event involving a vehicle 104 has occurred. For example, traffic cameras or other cameras may be used to supplement a prediction that an event occurred.

Alternatively or additionally, at step 316, the management model 288 may determine that the event occurred based on an output of a sub-model 298. The management model 288 may determine that the event occurred based on the set of rules (e.g., output of sub-model 298 matches rules or conditions provided at step 304). For example, the management model 288 may determine the event occurred if a vehicle crash sub-model 298 identifies that the vehicle 104 is involved in a crash.

At step 320, if an event occurred, the computing device 276 using the management model 288 may generate an output indicating that the event occurred. The computing device 276 and/or the management model 288 may further predict whether roadside assistance may be needed. In some embodiments, the computing device 276 and/or the management model 288 may generate a request for roadside assistance. At step 324, the computing device 276 may send an alert or notification that the event occurred. The alert or notification may be sent to a computing device connected to the network 124 or the device 296 associated with the human user 294. The request for roadside assistance may be transmitted to a service provider to provide the requested roadside assistance. Further, at step 324, the computing device 276 may send one or more commands to the computing devices in the system 100 and/or the device 296 associated with the human user 294 to display the event information.

Alternatively, if an event did not occur, at step 328, the computing device 276 using the management model 288 may generate an output indicating that an event did not occur. At step 332, the computing device 276 may send an alert or notification indicating that no event occurred, and one or more commands to the computing devices in the system 100 and/or the device 296 associated with the human user 294 to display that the event did not occur.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of “at least one” component, element, etc., should not be used to create an inference that the alternative use of articles “a” or “an” should be limited to a single component, element, etc. It is further noted that recitations herein of “a”, “an”, “the”, “at least one”, and “one or more” are used interchangeably to indicate that at least one of the item is present and a plurality of such items may be present unless the context clearly indicates otherwise. It is also noted that recitations herein of a component of the present disclosure being “configured” or “programed” in a particular way, to embody a particular property, or to function in a particular manner, are structural recitations, as opposed to recitations of intended use.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Representative Features

Representative features are set out in the following clauses, which stand alone or may be combined, in any combination, with one or more features disclosed in the text and/or drawings of the specification.

Clause 1. A method comprising: monitoring, using a model, a first output of a first sensor of a vehicle, the first output including vehicle data associated with the vehicle during a trip; monitoring, using the model, a second output of a second sensor of a mobile device, the second output including mobile device sensor data associated with the mobile device during the trip, the mobile device associated with a driver of the vehicle; processing, using the model, the vehicle data and the mobile device sensor data to detect a vehicle event occurred during the trip; predicting, using the model and based on the vehicle data and the mobile device sensor data, whether roadside assistance is needed for the vehicle event; based on the prediction that the roadside assistance is needed, generating a request for the roadside assistance; and transmitting the request for the roadside assistance to a service provider to provide the roadside assistance.

Clause 2. The method of Clause 1, further comprising: monitoring, using the model, a third output of a third sensor of an additional device, the third output including additional device data associated with the vehicle during the trip.

Clause 3. The method of any of Clause 1 to Clause 2, wherein the additional device is an image device or a traffic device.

Clause 4. The method of any of Clause 1 to Clause 3, further comprising: monitoring, using the model, an output of a sub-model running on the mobile device or the vehicle, wherein the sub-model analyzes an aspect of the vehicle including a vehicle acceleration, a vehicle velocity, or a vehicle orientation.

Clause 5. The method of any of Clause 1 to Clause 4, further comprising: processing, using the model, the vehicle data, the mobile device sensor data, and the output of the sub-model to detect the vehicle event occurred during the trip.

Clause 6. The method of any of Clause 1 to Clause 5, further comprising: comparing the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.

Clause 7. The method of any of Clause 1 to Clause 6, wherein the mobile device sensor data is processed on the mobile device, and wherein the vehicle data is processed at the vehicle.

Clause 8. A computing system comprising: a processor; a memory storing computer-executable instructions that, when executed by the processor, cause the processor to: monitor, using a model, a first output of a first sensor of a vehicle, the first output including vehicle data associated with the vehicle during a trip; monitor, using the model, a second output of a second sensor of a mobile device, the second output including mobile device sensor data associated with the mobile device during the trip, the mobile device associated with a driver of the vehicle; process, using the model, the vehicle data and the mobile device sensor data to detect a vehicle event occurred during the trip; predict, using the model and based on the vehicle data and the mobile device sensor data, whether roadside assistance is needed for the vehicle event; based on the prediction that the roadside assistance is needed, generate a request for roadside assistance; and transmit the request for roadside assistance to a service provider to provide the requested roadside assistance.

Clause 9. The computing system of Clause 8, wherein the computer-executable instructions, when executed by the processor, cause the processor to: monitor, using the model, a third output of a third sensor of an additional device, the third output including additional device data associated with the vehicle during the trip.

Clause 10. The computing system of any of Clause 8 to Clause 9, wherein the additional device is an image device or a traffic device.

Clause 11. The computing system of any of Clause 8 to Clause 10, wherein the computer-executable instructions, when executed by the processor, cause the processor to:
monitor, using the model, an output of a sub-model running on the mobile device or the vehicle, wherein the sub-model analyzes an aspect of the vehicle including a vehicle acceleration, a vehicle velocity, or a vehicle orientation.

Clause 12. The computing system of any of Clause 8 to Clause 11, wherein the computer-executable instructions, when executed by the processor, cause the processor to:
process, using the model, the vehicle data, the mobile device sensor data, and the output of the sub-model to detect the vehicle event occurred during the trip.

Clause 13. The computing system of any of Clause 8 to Clause 12, wherein the computer-executable instructions, when executed by the processor, cause the processor to:
compare the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.

Clause 14. The computing system of any of Clause 8 to Clause 13, wherein the mobile device sensor data is processed on the mobile device, and wherein the vehicle data is processed at the vehicle.

Clause 15. One or more non-transitory computer-readable media storing instructions that, when executed by a processor, cause the processor to: monitor, using a model, a first output of a first sensor of a vehicle, the first output including vehicle data associated with the vehicle during a trip; monitor, using the model, a second output of a second sensor of a mobile device, the second output including mobile device sensor data associated with the mobile device during the trip, the mobile device associated with a driver of the vehicle; process, using the model, the vehicle data and the mobile device sensor data to detect a vehicle event occurred during the trip; predict, using the model and based on the vehicle data and the mobile device sensor data, whether roadside assistance is needed for the vehicle event; based on the prediction that the roadside assistance is needed, generate a request for the roadside assistance; and transmit the request for the roadside assistance to a service provider to provide the roadside assistance.

Clause 16. The non-transitory computer-readable media storing instructions of Clause 15, when executed by the processor, cause the processor to: monitor, using the model, a third output of a third sensor of an additional device, the third output including additional device data associated with the vehicle during the trip.

Clause 17. The non-transitory computer-readable media storing instructions of any of Clause 15 to Clause 16, wherein the additional device is an image device or a traffic device.

Clause 18. The non-transitory computer-readable media storing instructions of any of Clause 15 to Clause 17, when executed by the processor, cause the processor to: monitor, using the model, an output of a sub-model running on the mobile device or the vehicle, wherein the sub-model analyzes an aspect of the vehicle including a vehicle acceleration, a vehicle velocity, or a vehicle orientation.

Clause 19. The non-transitory computer-readable media storing instructions of any of Clause 15 to Clause 18, when executed by the processor, cause the processor to: process, using the model, the vehicle data, the mobile device sensor data, and the output of the sub-model to detect the vehicle event occurred during the trip.

Clause 20. The non-transitory computer-readable media storing instructions of any of Clause 15 to Clause 19, when executed by the processor, cause the processor to: compare the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.

It is noted that one or more of the following claims utilized the term “wherein” as a transitional phrase. For the purposes of defining the present disclosure, it noted that his term is an open-ended transitional term that is used to introduce a recitation of a series of characteristics of the structure and should be interpreted in like manner as the more commonly used open-ended preamble term “comprising.”

Aspects of the disclosure have been described in terms of illustrative embodiment thereof. Numerous other embodiments, modifications, and variations within the scope and spirit of the appended claims will occur to persons of ordinary skill in the art from a review of this disclosure. For example, one or more steps depicted in the illustrative figures may be performed in a different order other than the recited order, and one or more depicted steps may be optional in accordance with aspects of the disclosure.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
monitoring, using a model, a first output of a first sensor of a vehicle, the first output including vehicle data associated with the vehicle during a trip;
monitoring, using the model, a second output of a second sensor of a mobile device, the second output including mobile device sensor data associated with the mobile device during the trip, the mobile device associated with a driver of the vehicle;
processing, using the model, the vehicle data and the mobile device sensor data to detect a vehicle event occurred during the trip;
predicting, using the model and based on the vehicle data and the mobile device sensor data, whether roadside assistance is needed for the vehicle event;
based on the prediction that the roadside assistance is needed, generating a request for the roadside assistance; and
transmitting the request for roadside assistance to a service provider to provide the roadside assistance.

2. The method of claim 1, further comprising:
monitoring, using the model, a third output of a third sensor of an additional device, the third output including additional device data associated with the vehicle during the trip.

3. The method of claim 2, wherein the additional device is an image device or a traffic device.

4. The method of claim 1, further comprising:
monitoring, using the model, an output of a sub-model running on the mobile device or the vehicle, wherein the sub-model analyzes an aspect of the vehicle including a vehicle acceleration, a vehicle velocity, or a vehicle orientation.

5. The method of claim 4, further comprising:
processing, using the model, the vehicle data, the mobile device sensor data, and the output of the sub-model to detect the vehicle event occurred during the trip.

6. The method of claim 1, further comprising:
comparing the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.

7. The method of claim 1, wherein the mobile device sensor data is processed on the mobile device, and wherein the vehicle data is processed at the vehicle.

8. A computing system comprising:
a processor;
a memory storing computer-executable instructions that, when executed by the processor, cause the processor to:
monitor, using a model, a first output of a first sensor of a vehicle, the first output including vehicle data associated with the vehicle during a trip;
monitor, using the model, a second output of a second sensor of a mobile device, the second output including mobile device sensor data associated with the mobile device during the trip, the mobile device associated with a driver of the vehicle;
process, using the model, the vehicle data and the mobile device sensor data to detect a vehicle event occurred during the trip;
predict, using the model and based on the vehicle data and the mobile device sensor data, whether roadside assistance is needed for the vehicle event;
based on the prediction that roadside assistance is needed, generate a request for roadside assistance; and
transmit the request for roadside assistance to a service provider to provide the requested roadside assistance.

9. The computing system of claim 8, wherein the computer-executable instructions, when executed by the processor, cause the processor to:
monitor, using the model, a third output of a third sensor of an additional device, the third output including additional device data associated with the vehicle during the trip.

10. The computing system of claim 9, wherein the additional device is an image device or a traffic device.

11. The computing system of claim 8, wherein the computer-executable instructions, when executed by the processor, cause the processor to:
monitor, using the model, an output of a sub-model running on the mobile device or the vehicle, wherein the sub-model analyzes an aspect of the vehicle including a vehicle acceleration, a vehicle velocity, or a vehicle orientation.

12. The computing system of claim 11, wherein the computer-executable instructions, when executed by the processor, cause the processor to:
process, using the model, the vehicle data, the mobile device sensor data, and the output of the sub-model to detect the vehicle event occurred during the trip.

13. The computing system of claim 8, wherein the computer-executable instructions, when executed by the processor, cause the processor to:
compare the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.

14. The computing system of claim 8, wherein the mobile device sensor data is processed on the mobile device, and wherein the vehicle data is processed at the vehicle.

15. One or more non-transitory computer-readable media storing instructions that, when executed by a processor, cause the processor to:
monitor, using a model, a first output of a first sensor of a vehicle, the first output including vehicle data associated with the vehicle during a trip;
monitor, using the model, a second output of a second sensor of a mobile device, the second output including mobile device sensor data associated with the mobile device during the trip, the mobile device associated with a driver of the vehicle;
process, using the model, the vehicle data and the mobile device sensor data to detect a vehicle event occurred during the trip;
predict, using the model and based on the vehicle data and the mobile device sensor data, whether roadside assistance is needed for the vehicle event;
based on the prediction that roadside assistance is needed, generate a request for roadside assistance; and
transmit the request for roadside assistance to a service provider to provide the requested roadside assistance.

16. The non-transitory computer-readable media storing instructions of claim 15, when executed by the processor, cause the processor to:
monitor, using the model, a third output of a third sensor of an additional device, the third output including additional device data associated with the vehicle during the trip.

17. The non-transitory computer-readable media storing instructions of claim 16, wherein the additional device is an image device or a traffic device.

18. The non-transitory computer-readable media storing instructions of claim 15, when executed by the processor, cause the processor to:
monitor, using the model, an output of a sub-model running on the mobile device or the vehicle, wherein the sub-model analyzes an aspect of the vehicle including a vehicle acceleration, a vehicle velocity, or a vehicle orientation.

19. The non-transitory computer-readable media storing instructions of claim 18, when executed by the processor, cause the processor to:
process, using the model, the vehicle data, the mobile device sensor data, and the output of the sub-model to detect the vehicle event occurred during the trip.

20. The non-transitory computer-readable media storing instructions of claim 15, when executed by the processor, cause the processor to:
compare the mobile device sensor data or the vehicle data to one or more thresholds indicating the roadside assistance is needed, the one or more thresholds including at least one a vehicle acceleration threshold, a vehicle velocity threshold, a vehicle location threshold, or a vehicle orientation threshold.
